(19) United States
(12) Patent Application Publication
(10) Pub. No.: US 2007/0239350 A1
(43) Pub. Date: Oct. 11, 2007

(54) Multi-function tracking device with robust asset tracking system

(76) Inventors: Philip J. Zumsteg, Shorewood, MN (US); Steve D. Huseth, Plymouth, MN (US)

Correspondence Address: Kris T. Fredrick, Esq.;Patent Services, Honeywell International Inc., 101 Columbia Road, Morristown, NJ, 07962, US

(21) Appl. No.: 11/399,855

(22) Filed: Apr. 7, 2006

(51) Int. Cl. G01C 21/00

(52) U.S. Cl. 701/207; 340/539.13

(57) ABSTRACT

A tracking system for tracking at least one mobile multi-function device in a defined area, including at least one mobile multi-function device adapted to move in the defined area. The multi-function devices including a transmitter and a device for determining the position of the device to transmit a signal including the determined position. A plurality of other multi-function devices are placed in and around the defined area to present an array of devices adapted to independently determine both the current position of the device and the accuracy of the position and communicate that to the other devices in the system using a mesh communication network. A signal processor receives the signals from the transmitters and calculate the position of the mobile multi-function device.

### FIELD OF THE INVENTION

The present invention relates to a tracking device and tracking system. More particularly, the present invention relates to the use of motion sensing, relative position determining, and wireless communication means in each tracking device. The tracking system comprises a fixed location, ad hoc emplacement and mobile tracking devices tracks and reports the locations, and the accuracy of the location information, of each device, even when devices in the system have been moved.

### BACKGROUND OF THE INVENTION

Radio Frequency (RF) based tracking systems rely on a combination of fixed beacons, or fixed location devices, and mobile devices, or tags, to track the movement of the devices, based on time-of-flight or signal strength measurements of specific RF signals. Near-continuous RF links between the mobile devices and the fixed location devices are necessary for the system to calculate timely location information. However, time-varying RF propagation may result in inaccurate location information for a mobile tag or tags. Further, if the required number of beacon signals are not available to locate a mobile tag, then a timely and accurate location for the tag cannot be determined or reported. The loss of enough beacon signals for determining the location of tracked devices is a problem with the use of the Global Positioning System (GPS) and with systems utilizing only beacons installed at fixed locations inside enclosed regions, such as buildings, structures and caves.

One method for location estimation de to insufficient GPS signals is disclosed in U.S. Pat. No. 6,473,038 to Patwari et al., the disclosure of which is incorporated herein by reference in its entirety. The method utilizes tabs which may be tracked by a variety of means, such as Angle of Arrival of RF signals from the tag to fixed location receivers using smart antennas, and modulated lights in specific rooms to indicate to the tag an approximate location. The accuracy of the tag locations determined by this method are not disclosed, though the light modulation technique has a location resolution of an entire room. Each of the approaches described requires either complex and expensive equipment, for the smart antennas, or room-level density infrastructures for the modulated light approach. The method further requires the use of a central processor to compute and track tag locations.

A more localized means of determining device location may be accomplished with sound or light using signal detection or propagation measurements. The maximum measurable range is limited by combinations of\signal attenuation, ambient noise and environmental barriers to sound or light propagation such as walls, floors, ceilings and the ground. Such methods require numerous devices to participate in location determination, many of which must have known fixed locations in the frame of reference desired for reporting mobile device location.

Determining the absolute location of each mobile tag using such RF signal acoustical or optical propagation methods requires a known frame of reference within which the mobile tags are used. The cost of such a frame of reference may be prohibitive, needing a high density f beacons for tag tracking. Further, since the overall system reliability is inversely proportional to the system complexity, the required high density of beacons may result in a lack of system availability due to device failures. Moreover, the RF, acoustical and optical approaches have error sources which exhibit cumulative effects such as multi-path in the RF and ambient noise in the acoustic and optical spectrums.

An alternative approach, which overcomes the RF link variability, limits acoustic and optic range, and fixed location device availability issues, employs motion sensing to detect when a device in the system moves. Such motion sensing may simply indicate the device has moved and any position reported by that device would be inaccurate. For a device providing the desired frame of reference, such location error would be uncompensated, and other devices which use such information would also determine inaccurate positions. Another motion sensing method is a dead-reckoning module (DRM) that may contain multiple sensors, such as altimeters, barometers, accelerometers, temperature sensors and compass sensors, for example. Such sensor data may be used to determine relative device movement, and hence changes in the device position. The RF link is then used solely for data communications between the devices.

One DRM is disclosed in U.S. Pat. No. 5,583,776 to Levi et al., the disclosure of which is incorporated by reference in its entirety. This DRM is a microcomputer-assisted position finding device that integrates GPS data, dead reckoning sensors, a barometric altitude sensor and digital maps, with a built-in RF transponder. The Levi et al. DRM provides ground speed/distance measurements and computer-aided position fixes. One such DRM is available from Point Research Corporation, of Santa Ana, Calif., as the product Dead Reckoning Module DRM®. The Dead Reckoning Module is a miniature, self-contained, electronic navigation unit that provides the user's position relative to an initialization point. The device includes a built-in GPS receiver. A microprocessor performs dead reckoning calculations and includes a Kalman filter to combine the dead reckoning data with GPS data. The Kalman filter and other proprietary algorithms use GPS data to calibrate dead reckoning sensors for typical dead reckoning accuracy of 2 to 5 percent of distance traveled from the last position fix, entirely without GPS. These devices are intended for use by personnel on foot, and are not for use on vehicles. Movement, or failure, of devices providing the frame of reference for position reporting may degrade the accuracy of the position location information. Specifically, the sue of RF tracking systems to monitor persons equipped with mobile tags, such as first responders in a structure, may encounter a catastrophic event such as a building collapses, leading to the effective re-location of one or more of the fixed location devices. In this case, the reporting tag location will be corrupt due to displacement of the fixed location devices and subsequent loss of the required absolute location frame of reference provided by the beacon receivers. Further, the positions of tracked devices are only available when the fixed location devices are operational throughout the regions of the structure where the first responders are moving and the central processing location for the system is operational and accessible to these devices.

It would be of advantage in the art if a system could be devised that would permit the use of an array of devices capable of independently determining their own position, without a central processing location, that would maintain their utility even when moved due to outside influences such as damage to the place where the they are mounted.

Yet another advantage would be if a tracking tag could be developed that would allow the device itself to measure its movement, process the movement data, calculate the device's new position, then transmit that data to other devices for possible display and coordination with other devices.

Still another advantage would be if such devices could be placed so as to form a local frame of reference in an ad hoc manner.

Other advantages will appear hereinafter.

### SUMMARY OF THE INVENTION

It has now been discovered that the above and other advantages of the present invention may be obtained in the following manner. Specifically, the present invention provides a system for tracking persons and other assets within one or more absolute or relative frames of reference defined by the locations of multi-function devices in the system. Multi-function devices in such as system may be mounted at fixed locations, emplaced in an ad hoc manner, or be mobile. The term “fixed” is intended here to include devices that are permanently mounted in place, devices that are temporarily mounted in place, and devices that are placed simply by setting them in place. These latter can be placed by the first responder going in, or, by others forming part of the networks described below, and would include devices fixed by being in a vehicle that is not moving.

Each multi-function device of the present invention includes a means for determining the device's location relative to other multi-function devices in the system, detecting motion of the device, processing the detected motion to determine changes in device position, determining the accuracy of the reported position, communicating the device's position to other devices in the system, and storing the reported positions and associated accuracy of the position in formation from other multi-function devices in the system.

The present invention is admirably suited for use in buildings and particularly in buildings that may be at risk from damage, such as by earthquake, hurricanes, tornados, wars, terrorism and the like. First responders will be dispatched and, thus, will be at risk themselves. For this reason the present invention is used to monitor their location and condition. In the case of a first responder scenario, such as a collapsed building, for example, multiple beacon receivers previously deployed on different floors of the building may now have ‘pancaked’ and appear to be on the same floor. Since the motion sensing in each beacon has measured the movement, the device may report the new location of the device, along with the accuracy of the reported position, and this data subsequently reported to other devices to use in their position determination. This ongoing capability even though devices providing the frame of reference for location reporting g have moved is essential for maintaining accurate position information from mobile tags on the first responders in the building.

The present invention provides a robust system for tracking devices, using one or a combination of multiple methods for position determination. Further, each multi-function device independently determines both the current position of that device and the accuracy of the position, which is communicated to any or all of the other multi-function devices in the system using a mesh communication network in which all the devices may communicate. Each multi-function device stores position information for that device and position information received from other devices, accompanied with a timestamp. As a result, the present invention is capable of improving accuracy and timeliness of location information and has flexibility of operation through independent determination of position by each multi-function device.

### BRIEF DESCRIPTION OF THE DRAWINGS

For a more complete understanding of the invention, reference is hereby made to the drawings, in which:

FIG. 1 is a schematic view illustrating a mesh communication between multi-function devices in the system of the present invention;

FIG. 2 is a schematic view illustrating a change in position of one multi-function device using trialteration before and after movement of a device to provide a frame of reference in the system of this invention;

FIG. 3 is a schematic view of a multi-function device of the present invention; and

FIG. 4 is a schematic view of a flowchart of the behavior of a multi-function device of the present invention.

### DETAILED DESCRIPTION OF THE PREFERRED EMBODIMENT

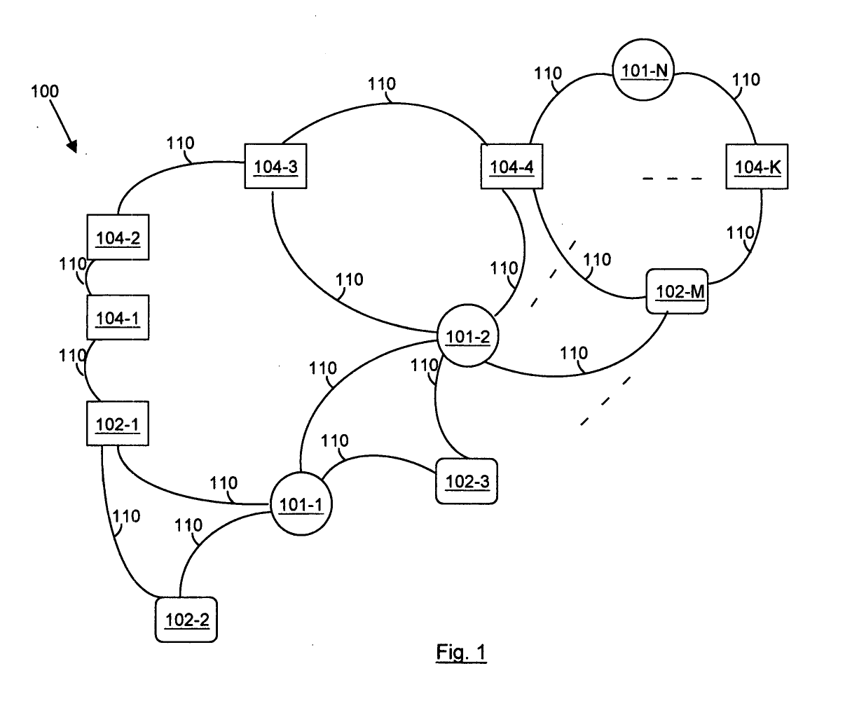

The present invention provides for substantial improvements in a tracking system using an improved multi-function tag or module. As shown in FIG. 1, a system 100 has a plurality of multi-function devices 101-1 through 101-N, 102-1 through 102-M and 104-1 through 104-K, all of which are adapted to communicate with each other using telecommunication links 110 to create a mesh network. One or more pluralities of devices in the system, such as 102-a through 102-M and 104-1 through 104-K, may use the mesh communication network to form one or more frames of reference for location determination by a plurality of other devices, such a 101-1 through 1-1-N. Each of the plurality of devices 101-N,102-M, and 104-K that that form each frame of reference may. belong to one or more of the frames of reference. Hence, any multi-function device may independently determine position by interacting with one or more other multi-function devices.

As shown in FIG. 1, a position tracking and reporting system 100 can include a plurality of fixed location multi-function devices 104-1 through 104-K fixedly mounted in known locations. Each of these devices is configured during installation with information including but not limited to an unique device identification value, motion sensor calibration and position information corresponding to the fixed mounting location of the device, such as at a particular location in a building. Each device 104-K includes a motion sensing means to determine movement of that device in order to determine the position of a specific device 104, independent of any other device 101-N, 102-M, or 104-K, based on motion detection since the previous stored location determination of a specific device 104.

Multi-function devices 104-K also include a processing means for functions including, but not limited to, computation of motion sensor and position data for determination of position and accuracy, obtaining a local clock time value, exchange of an unique identifier value for each device in a system 100, exchange of location and accuracy information with other multi-function devices in system 100, and storage of position information from one or more other multi-function devices in system 100. Each device 104-K includes a means for determining the location of the device 104-K relative to one or more other multi-function devices in system 100. Further, devices 104-K include a means for communicating with one or more other devices in system 100 in order to form a mesh network with other devices for the purposes of, but not limited to, exchange of position and accuracy information. A plurality of devices 104-K configured to provide a fixed frame of reference is able to provide absolute location information to, and obtain absolute information from, other multi-function devices 101-N, 102-M and 104-K using the plurality of devices 104-K fixed frame of reference. One or more devices 104-K in FIG. 1 may not be included in the plurality forming a fixed frame of reference, such as devices 104-1 and 104-2, which are adapted to interface a multi-function device 104-K to external signals for purposes including, but not limited to, display of device locations and frames of reference.

Also shown in FIG. 1, location tracking and reporting system 100 can contain a plurality of emplaced multi-function devices 102-1 through 102-M, whose location is typically static, but not fixedly mounted in known locations, such as devices placed by first responders as they work in a building. A plurality of devices 102-M may be emplaced to form one or more relative frames of reference for location determination. Multi-function devices in system 100 utilizing such relative frames of reference for independent location determination will provide location information based on the relative frame of reference, rather than the fixed frame of reference provided by devices 104-K. One or more of the devices 102-M forming a relative frame of reference may participate in a fixed frame of reference provided by a plurality of devices 104-K, and transform the relative frame of reference into a fixed frame of reference. Each device 102-M is configured during installation with information including, but not limited to, an unique device identification value, motion sensor initialization and calibration. Location information corresponding to the emplaced location of the device as determined by processing the motion sensor data as the device 102-M is emplaced after configuration. Each device 102-M includes a motion sensing means to determine movement of the device 102-M in order to determine the location of a specific device 102, independent of any other device in system 100, based on motion detected since the previous stored location determination of a specific device 102.

Multi-function devices 102-M also include a processing means for functions including, but not limited to, computation of motion sensor and location data for determination of location and accuracy, obtaining a local clock time value, exchange of unique identifier value for each device in system 100, exchange of location and accuracy information with other multi-function devices in system 100, and storage of location information from one or more other multi-function devices in system 100. Each device 102-M includes a means for determining the location of the device 102-M relative to one or more other multi-function devices in system 100. Further, devices 102-M include a means for communicating with one or more other devices in system 100 in order to form a mesh network with other devices for the purposes of, but not limited to, exchange of position and accuracy information. A plurality of devices 102-M configured to provide a relative frame of reference is able to provide relative position information, and obtain relative position information from, other multi-function devices 101-N and 102-M using the plurality of devices 102-M relative frame of reference. One or more devices 102-M in FIG. 1 may not be included in the plurality forming a fixed frame of reference, such as devices 102-a, which are adapted to interface a multi-function device 102-M to external signals for purposes including, but not limited to, display of device position and frames of reference.

The system 100 shown in FIG. 1 can contain a plurality of mobile multi-function devises 101-1 through 101-N, with locations that are expected to change, such as multi-function devices worn by first responders working in a building. A plurality of mobile devices 101-N may form one or more relative frames of reference for position determination. Multi-function devices in system 100 utilizing such relative frames of reference for independent position determination will provide position information based on the relative frame of reference, rather than the fixed frame of reference provided by devices 104-K. One or more of the devices 101-N forming a relative frame of reference may participate in a fixed frame of reference provided by a plurality of devices 104-K, and transform the relative frame of reference into the fixed frame of reference, thereby extending the fixed frame of reference until movement by one or more of the plurality of devices 101-N that were transformed into the fixed frame of reference. One or more of the devices 101-N forming a relative frame of reference may participate in a relative frame of reference provided by a plurality of devices 101-N or 102-M, thereby extending the relative frame of reference until movement by one or more of the plurality of devices 101-N that were transformed into the relative frame of reference.

Each mobile device 101-N is configured during installation with information including, but not limited to, a unique device identification value, motion sensor initiation and calibration. Position information corresponding to the current position of the device as determined by processing the motion sensor data and inter-device position measurements as the device 101-N is moved after configuration, such as multi-function devices 101-N worn by first responders moving through a building. Each device 101-N included a motion sensing means to determine movement of the device 101-N in order to determine the position of a specific device 101. Mobile multi-function devices 101-N also include a processing means for functions including, but not limited to, computation of motion sensor and position data for determination of position and accuracy, obtaining a local clock time value, exchange of an unique identifier value for each device in system 100, exchange of position and accuracy information from one or more other multi-function devices in system 100, and storage of position information from one or more other multi-function devices in system 100.

Each mobile device 101-N includes a means for determining the position of the device 101-N relative to one or more other multi-function devices in system 101. Further, devices 101-N include a means for communicating with one or more other devices in system 100 in order to form a mesh network with other devices for the purpose of, but not limited to, exchange of position and accuracy information. A plurality of devices 101-N configured to provide a relative frame of reference is able provide relative position information to, and obtain relative position information from, other multi-function devices 101-N and 102-M using the plurality of devices 102-M relative frame of reference. Mobile devices 101-N are adapted to interface a mobile multi-function device 101-N to external signals for purposes including, but not limited to, display of device positions and frames of reference.

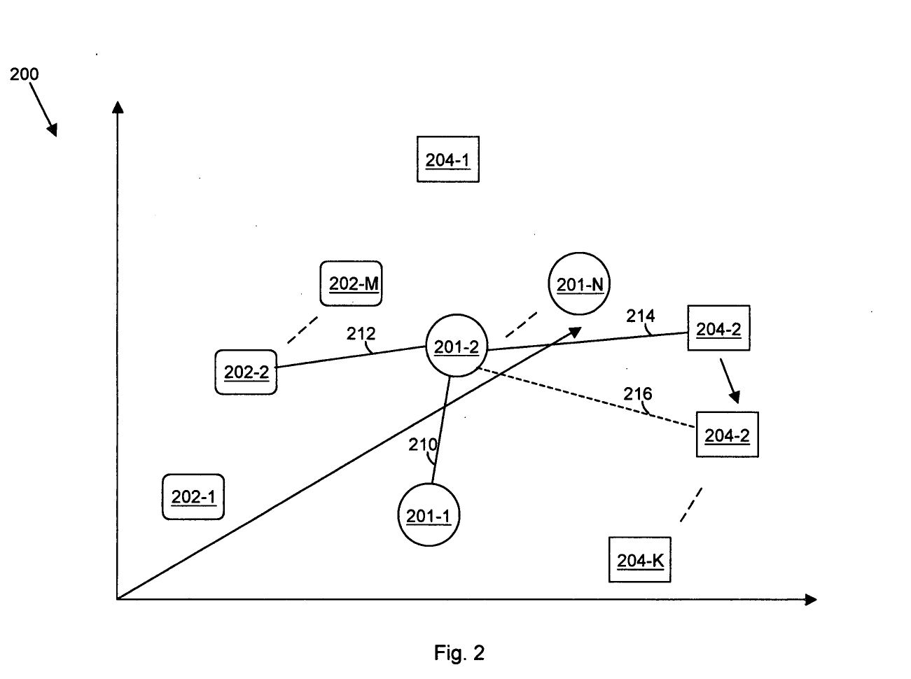

FIG. 2 illustrates an exemplary situation 200 of a fixed position device 204-2 moving from a configured position to a new position. As will be understood, many different combinations of fixed position, emplacement and mobile multi-function device positions are possible. Mobile device 201-2 performs position determination based on position measurement 212 with emplaced device 202-2, position measurement 210 with mobile device 201-1 and position measurement 214 with fixed position device 204-2. Subsequently, fixed device 204-2 moves to a new position, such as during the collapse of the fixed mounting of device 204-2. Fixed position device 2042 utilizes motion sensor data during the movement to subsequently determine new position and accuracy information. Fixed device 204-2 exchanges the new position and accuracy information with one or more multi-function devices including device 202-2 using the mesh communication network. Mobile device 201-2 uses both the new position and accuracy information received from fixed position device 204-2, and the new position measurement 216 with fixed device 204-2 to revise the position determination and accuracy information for mobile device 201-2. Mobile device 201-2 then exchanges the revised position and accuracy information with other multi-function devices using the mesh communications network.

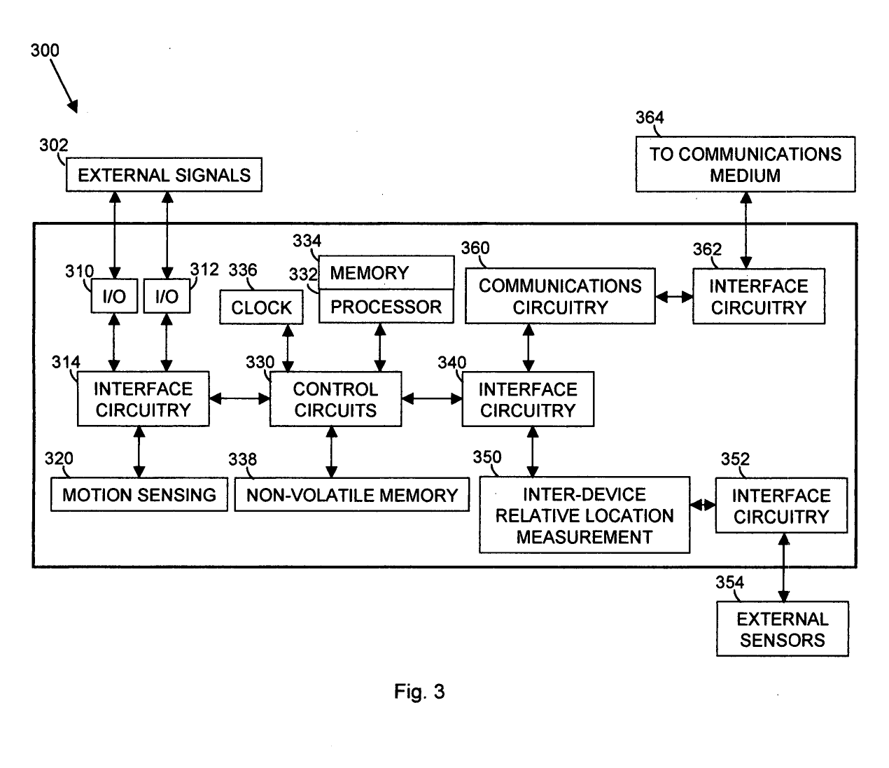

FIG. 3 is a block diagram of a preferred embodiment of a multi-function device 300 of the present invention. It will be understood that the device 300 illustrated in FIG. 3 is exemplary only and is not a limitation of the present invention. Those of skill in the art will understand that motion sensing includes determining when motion is present, when motion is not present, and the determination of parameters related to motion including but not limited to, compass heading, altitude, acceleration and other data indicating a change in position or direction or a lack thereof.

Multi-function device 300 can incorporate a non-volatile memory or storage unit 338 for purposes of storing control software, configuration information, processed data, and positions and accuracies of other devices, all without limitation.

The multi-function device 300 can incorporate control circuits 330 coupled to non-volatile memory 338, interface circuitry 314, clock 336, programmable processor 332 and interface circuitry 340. The device 300 can incorporate additional storage 334 of a type that would include, for example, read/write memory of a volatile or non-volatile form.

Multi-function device 300 can incorporate input/output 310 and 312 coupled with external signals 302, the plurality of which is not a limitation of device 300. Input/output 310 and 312 can be coupled to interface circuitry 314, to adapt the signals between in put/out 310 and 312 and control circuits 330. The plurality of input/output signals 310 and 312 is not a limitation of the present invention.

Interface circuitry 314 can be coupled to motion sensor 320 to adapt the signals between the motion sensor 320 and control circuits 330. In one preferred embodiment of this invention, the motion sensor 320 can incorporate sensors necessary for dead-reckoning (DR) navigation, including, but not limited to, one or more accelerometers, altimeters, compass heading devices, tilt sensors and temperature sensors.

Device 300 can incorporate interface circuitry 340 which can be coupled to control circuits 330, inter-device position measurement 350 and communication circuitry 360.

In one preferred embodiment of device 300, the inter-device position measurement is performed by trilateration, as shown in FIG. 2, or multi-lateration using radio frequency (RF) signals from a plurality of other multi-function devices 300. As would be understood, other means and combinations of inter-device position measurement may be used, including but not limited to measuring various properties and relationships of RF, audio, and optical signals. Interface circuitry 352 can couple external sensors 354 to adapt signals between the inter-device relative position measurement 350 and external sensors 354.

Interface circuitry 362 can be coupled to communication circuitry 360 to adapt signals between communications circuitry 360 and the communications medium 364. In one preferred embodiment of device 300, the communication circuitry 360 incorporates a radio providing mesh communications with other devices 400. As can be seen, other means and combinations may be used, including but not limited to RF, audio, and optical signals.

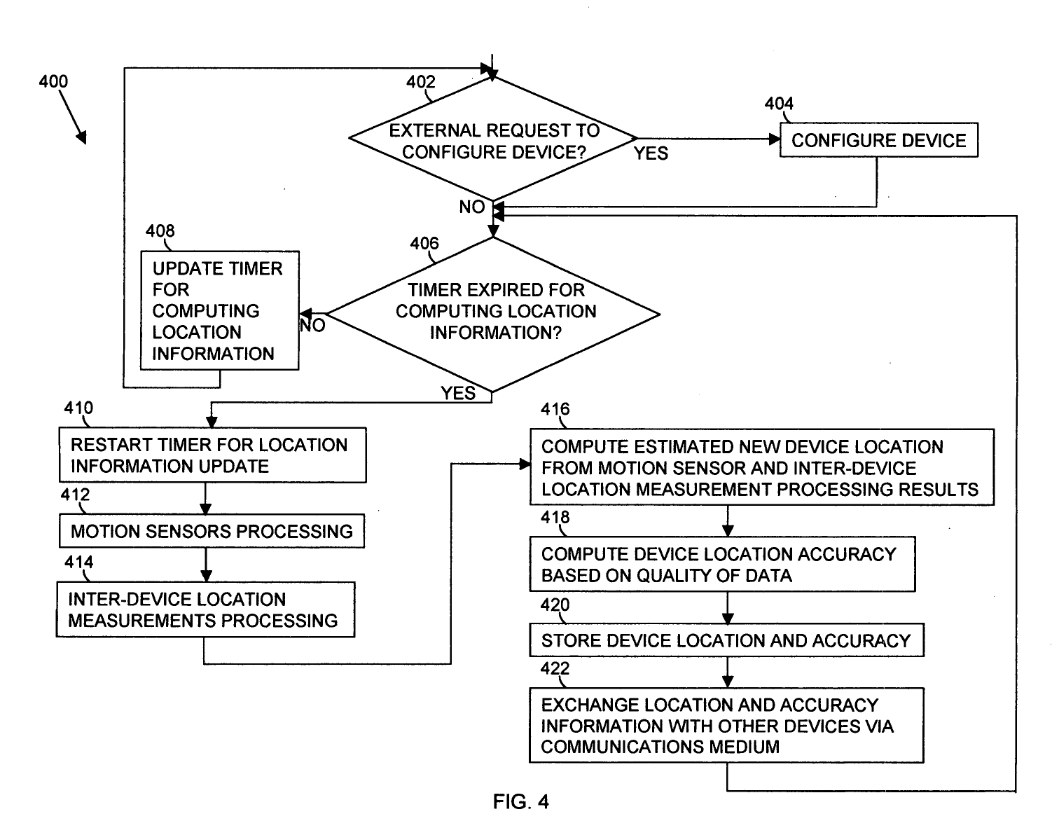

FIG. 4 is a flow diagram of a process 400, executed in whole or in part by each multi-function device 300, of FIG. 3, to determine device position and accuracy information using motion sensing and inter-device position and accuracy information.

In step 402, a determination is made as to whether an external configuration request requires processing. Such a request may be obtained by the multi-function device from, for example, external signals 302 or via the communications medium 364 of FIG. 3.

In step 404, an external configuration request determined from step 402 is processed. This processing may include, for example, initialization of selected memory positions, calibration of motion sensor values, storage of externally supplied position and accuracy information, and storage of externally supplied unique identification values.

In step 406, a determination is made as to whether the timer providing the periodic indication for updating device position and accuracy information has expired. If the timer has not expired, the timer value is updated in step 408, and the process 400 returns to determine the presence of an external configuration request in step 402.

In step 410, the expired timer is restarted to provide a periodic interval for updating device position and accuracy information.

In step 412, the motion sensors data is obtained and processed to determine movement of the device relative to the device position previously stored in step 420.

In step 414, the inter-device position measurement data is obtained and processed to determine the device position and accuracy within the frame of reference provided by other multi-function devices. Such inter-device position measurement data may include information regarding other device positions and accuracies obtained during a communication exchange in step 422.

In step 416, new position information is computed by the device. Clearly, the new position information computed b y a device may use one or more sets of data from the motion sensor and inter-device measurements. If a plurality of such data sets is available, then the processing will take place relative to at least selected data sets.

In step 418, the computed position and accuracy information is determined from the quality of selected data sets in the processing in step 416. If a plurality of such data sets are available, then the processing will take place relative to at least selected data sets.

In step 420, the newly computed position and accuracy measurements are stored in memory positions, such as in non-volatile memory 338, memory334 and programmed processor 332 as shown in FIG. 3.

In step 422, the newly computed position and accuracy information are exchanged with other multi-function devices. Position and accuracy information received from other multi-function devices is stored in memory positions, such as in non-volatile memory 338, memory 334 and programmed processor 332 as shown in FIG. 3.

Following step 422, the process 400 returns to step 402 to provide a continuous and timely position determination multi-function device.

As can be seen from the above description, the multi-function devices are designed to “transmit” information relating to position and accuracy and to receive information from other devices. Transmission has been shown to be by RF signals, acoustic signals and optical signals, all of which are included in the term “transmitter/receiver” as set forth in the claims. Also, DRM device is intended to include any device that measures, stores, transmits and receives the required information.

While particular embodiments of the present invention have been illustrated and described, it is not intended to limit the invention, except as defined by the following claims. Start here

1. A tracking system for tracking at least one mobile multi-function device in a defined area, comprising:
at least one mobile multi-function device adapted to move in said defined area, said multi-function device including a transmitter/receiver and DRM device for determining the position of said multi-function device, said transmitter/receiver being adapted to transmit and receive a signal including data from said DRM device representative of said determined position;
a plurality of multi-function devices spaced in said defined area to present an array of multi-function devices, each of said multi-function devices having a transmitter/receiver and DRM device, said plurality of multi-function devices being adapted to independently determine both the current position of said device and the accuracy of its position and transmit said position and accuracy to other multi-function devices in the system using a mesh communication network in which all the devices may communicate; and
a signal processor positioned to receive transmitter signals from said transmitter/receiver and calculate the position of said mobile multi-function device.

2. The tracking system of claim 1, wherein said multi-function devices include a processor for storing and updating position and accuracy data from itself and from other multi-function devices in said system.

3. The tracking system of claim 1, wherein said plurality of multi-function devices includes at least two sets of pluralities of multi-function devices, each of said sets of pluralities of multi-function devices being adapted to form at least one separate frame of reference adapted to form a mesh network, said frame of reference being adapted to locate the position of said at least one mobile multi-function device.

4. The tracking system of claim 3, wherein said at least one separate frame of reference forms a single frame of reference for all of said plurality of multi-function devices.

5. The tracking system of claim 3, wherein said at least one separate frame of reference forms a separate frame of reference for each of said at least two pluralities of multi-function devices.

6. The tracking system of claim 1, wherein said plurality of multi-function devices includes a plurality of fixed position devices, said fixed position devices being selected from the group consisting of devices that are permanently mounted in place, devices that are temporarily mounted in place, devices that are placed by one carrying said mobile device, devices that are set in place by another, and combinations thereof.

7. The tracking system of claim 6, wherein fixed position devices are configured during installation with information including an unique device identification value, motion sensor calibration and position information corresponding to the fixed mounting location of the device.

8. The tracking system of claim 1, wherein said plurality of multi-function devices include a motion sensor for sensing movement from said fixed position and causing said devices to recalculate their positions and transmit said recalculated position to said other multi-function devices in said system.

9. The tracking system of claim 8, wherein said motion sensor includes sensors necessary for dead-reckoning (DR) navigation, including one or more accelerometers, altimeters, compass heading devices, tilt sensors and temperature sensors.

10. The tracking system of claim 1, wherein each multi-function device includes a clock time for recording the time for each data being acquired, said device being adapted to chronologically store said data according to said clock time.

11. A tracking system for tracking at least one mobile multi-function device in a defined area, comprising:
at least one mobile multi-function device adapted to move in said defined area, said multi-function device including a transmitter/receiver means for transmitting signals and DRM device means for determining the position of said multi-function device, said transmitter/receiver means being adapted to transmit a signal including data from said DRM device means representative of said determined position;
a plurality of multi-function device means for tracking said mobile multi-function device and having transmitter/receiver means for transmitting data and DRM means for determining the position of said multi-function device means and being spaced in said defined area to present an array of multi-function device means, each of said multi-function device means adapted to independently determine both the current position of said device and the accuracy of its position and transmit said position and accuracy to other multi-function device means in the system using a mesh communication network in which all the device means may communicate; and
signal processor means for receiving transmitter signals from said transmitter/receiver means and calculate the position of said mobile multi-function device.

12. The tracking system of claim 11, wherein said multi-function device means include a processor means for storing and updating position and accuracy data from itself and from other multi-function device means in said system.

13. The tracking system of claim 11, wherein said plurality of multi-function device means includes at least two sets of pluralities of multi-function device means, each of said sets of pluralities of multi-function device means being adapted to form at least one separate frame of reference adapted to form a mesh network, said frame of reference being adapted to locate the position of said at least one mobile multi-function device.

14. The tracking system of claim 13, wherein said at least one separate frame of reference forms a single frame of reference for all of said plurality of multi-function devices.

15. The tracking system of claim 13, wherein said at least one separate frame of reference forms a separate frame of reference for each of said at least two pluralities of multi-function device means.

16. The tracking system of claim 11, wherein said plurality of multi-function device means includes a plurality of fixed position device means, said fixed position device means being selected from the group consisting of means that are permanently mounted in place, means that are temporarily mounted in place, means that are placed by one carrying said mobile device, means that are set in place by another, and combinations thereof.

17. The tracking system of claim 16, wherein fixed position device means are configured during installation with information including an unique device identification value, motion sensor calibration and position information corresponding to the fixed mounting location of the device means.

18. The tracking system of claim 11, wherein said plurality of multi-function device means include a motion sensor for sensing movement from said fixed position and causing said devices to recalculate their positions and transmit said recalculated position to said other multi-function device means in said system.

19. The tracking system of claim 18, wherein said motion sensor includes sensors necessary for dead-reckoning (DR) navigation, including one or more accelerometers, altimeters, compass heading devices, tilt sensors and temperature sensors.

20. The tracking system of claim 11, wherein each multi-function device means includes a clock time means for recording the time for each data being acquired, said device means being adapted to chronologically store said data according to said clock time means.
